(19) United States
(12) Patent Application Publication
(10) Pub. No.: US 2007/0024917 A1
(43) Pub. Date: Feb. 1, 2007

(54) Device access area illumination in an imaging apparatus

(75) Inventors: Mark J. Edwards, Lexington, KY (US); Jeffrey R. Ehlert, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/192,917

(22) Filed: Jul. 29, 2005

(51) Int. Cl. H04N 1/00

(52) U.S. Cl. 358/401

(57) ABSTRACT

An imaging apparatus having a device access area includes a light source mounted to the imaging apparatus, the light source being positioned to illuminate the device access area to counter darkness in the device access area of the imaging apparatus.

### BACKGROUND OF THE INVENTION

1. Field of the Invention.

The present invention relates to an imaging apparatus, and, more particularly, to device access area illumination in an imaging apparatus.

2. Description of the Related Art.

An all-in-one (AIO) imaging machine, also sometimes known as a multifunction machine, typically combines an ink jet printer and a flatbed scanner. AIOs are becoming more popular as prices continue to decrease and the amount of functionality increases. The ink jet printer versions of AIO machines generally result in lower box cost. Usually, in this type of AIO machine the scanning unit is mounted above the ink jet printing unit. The result is a machine that looks very much like a copier. A problem also results in that access to the ink jet printhead cartridges in the printing unit can be difficult. Most AIO machines hinge the scanner portion so that it may be tipped up to allow access to the cartridge installation/removal area of the printing unit. A problem for such AIO machines is that the access area is still rather dark. In many such AIO machines, the visual cue to identify the Black vs. the Color printhead cartridge is the cartridge plastic top color. Unfortunately, the access cavity in the printing unit is darkest near the top of the printhead cartridge, and identification may be difficult.

### SUMMARY OF THE INVENTION

The present invention provides illumination for a device access area in an imaging apparatus.

The invention, in one exemplary embodiment, is directed to an imaging apparatus having a device access area. The imaging apparatus includes a light source mounted to the imaging apparatus. The light source is positioned to illuminate the device access area to counter darkness in the device access area of the imaging apparatus.

The invention, in another exemplary embodiment, is directed to an imaging apparatus. The imaging apparatus includes a printing unit including at least one replaceable supply item, and a supply item access area associated with the at least one replaceable supply item. A scanning unit is pivotably attached to the printing unit. The scanning unit has a closed position and an opened position in relation to the printing unit. A switch is positioned to detect when the scanning unit is moved from the closed position toward the opened position. A light source is coupled to the switch. The light source is positioned to provide light to illuminate the supply item access area.

The invention, in another exemplary embodiment, is directed to a method for use with an imaging apparatus having a device access area and a light source mounted to the imaging apparatus. The method includes emitting light from the light source to illuminate the device access area of the imaging apparatus to counter darkness in the device access area.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1A is a perspective view of an imaging apparatus embodying the present invention, with the scanning unit in a closed position with respect to the printing unit.

FIG. 1B is a perspective view of the imaging apparatus of FIG. 1A, with the scanning unit closed with respect to the printing unit, and with the scanner lid in an opened position with respect to the scanner body.

FIG. 1C is a perspective view of the imaging apparatus of FIG. 1A, with the scanning unit in an opened position with respect to the printing unit.

FIG. 2 is a diagrammatic representation of an imaging system incorporating the imaging apparatus of FIGS. 1A-1C, and including a light source for illuminating a device access area in the imaging apparatus.

FIG. 3 is a diagrammatic representation of the imaging apparatus of FIGS. 1A-1C, and including the light source for illuminating a device access area in the imaging apparatus being mounted to the scan bar of the scanning unit.

FIG. 4 is a diagrammatic representation of an embodiment of the imaging apparatus of FIGS. 1A-1C, wherein the light source includes a light emitter and a light directing device.

FIG. 5A is a diagrammatic representation of an embodiment of the light source of FIG. 4, wherein the light directing device is a lens.

FIG. 5B is a diagrammatic representation of an embodiment of the light source of FIG. 4, wherein the light directing device is a light pipe.

FIG. 5C is a diagrammatic representation of an embodiment of the light source of FIG. 4, wherein the light directing device is a fiber optics cable.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

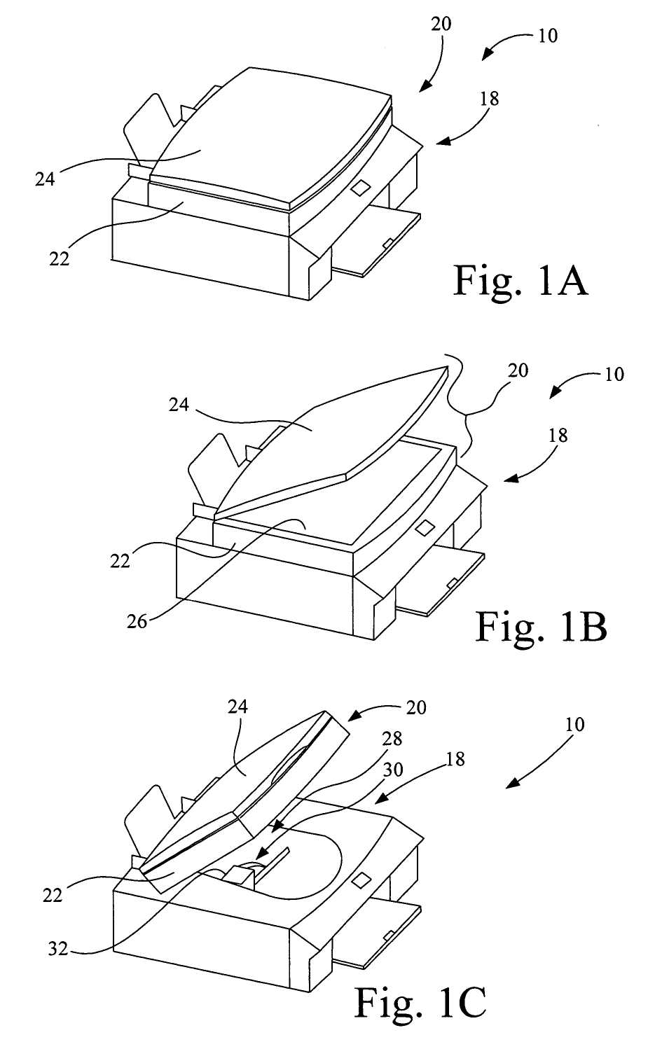

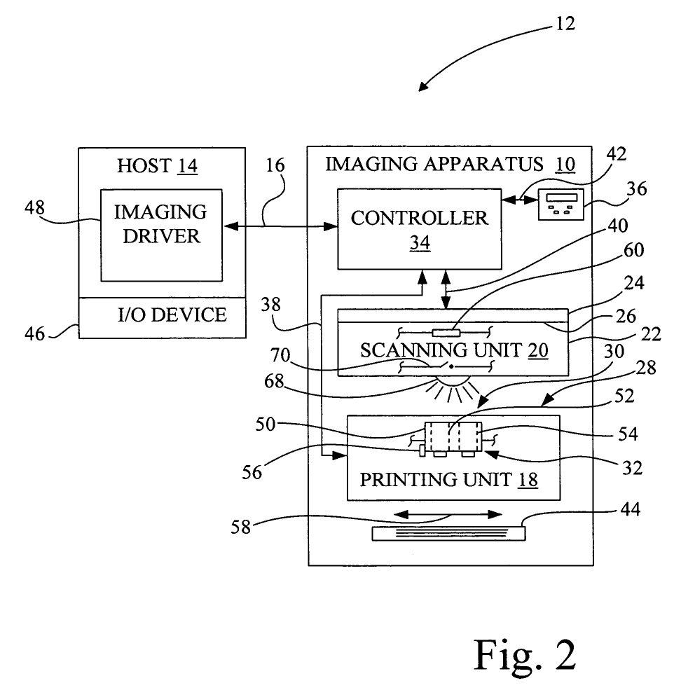

Referring now to the drawings and particularly to FIGS. 1A-1C, there are shown perspective views of an imaging apparatus 10. Imaging apparatus 10 may be incorporated into an imaging system 12, as diagrammatic depicted in FIG. 2, and may be communicatively coupled to a host 14 via a communications link 16.

Imaging apparatus 10 may communicate with host 14 via a standard communication protocol, such as for example, universal serial bus (USB) or Ethernet. As used herein, the term “communications link” is used to generally refer to structure that facilitates electronic communication between two components, and may operate using wired or wireless technology. Communications link 16 may be established, for example, by a direct cable connection, wireless connection or by a network connection, such as for example an Ethernet local area network (LAN).

Alternatively, imaging apparatus 10 may be a standalone unit that is not communicatively linked to a host, such as host 14. For example, imaging apparatus 10 may take the form of a multifunction machine, e.g., an all-in-one (AIO) machine, which includes standalone copying and facsimile capabilities, in addition to optionally serving as a printer when attached to a host, such as host 14.

As an AIO machine, imaging apparatus 10 includes a printing unit 18 and a scanning unit 20. Scanning unit 20 is pivotably attached to printing unit 18 to be movable with respect to printing unit 18. Scanning unit 20 has a scanner body 22, and a scanner lid 24 pivotably attached to scanner body 22 to be movable with respect to scanner body 22. FIGS. 1A and 1B show scanning unit 20 in a closed position with respect to printing unit 18. FIG. 1C shows scanning unit 20 in an opened position with respect to printing unit 18. FIG. 1A shows scanner lid 24 in a closed position with respect to scanner body 22. FIG. 1B shows scanner lid 24 in an opened position with respect to scanner body 22.

During periods of nonuse of imaging apparatus 10, scanning unit 20 is in the closed position and scanner lid 24 is in the closed position, as depicted in FIG. 1A. During a scanning operation, scanner lid 24 is opened (FIG. 1B) and a document is placed on a transparent document table 26. Thereafter, scanner lid 24 is closed, as shown in FIG. 1A. During a supply item installation/removal operation, scanning unit 20 is placed in the opened position, as shown in FIG. 1C.

Referring to FIG. 1C, printing unit 18 includes a device access area 28. The term “device access area” is used to generally describe an area of imaging apparatus 10 where servicing of imaging apparatus 10 takes place, such as for example, a supply item access area 30 where one or more replaceable supply items 32, such as an inkjet printhead cartridge, may be removed from and/or installed in imaging apparatus 10, or in an area where some other user interactive function occurs, such as routine cleaning of imaging apparatus 10.

Referring to FIG. 2, in addition to the components identified above, imaging apparatus 10 includes, for example, a controller 34 and a user interface 36. Controller 34 includes a processor unit and associated memory, and may be formed as an Application Specific Integrated Circuit (ASIC). Controller 34 communicates with printing unit 18 via a communications link 38. Controller 34 communicates with scanning unit 20 via a communications link 40. Controller 34 communicates with user interface 36 via a communications link 42. Communications links 38, 40 and 42 may be established, for example, by using standard electrical cabling or bus structures, or by wireless connection.

In the context of the examples for imaging apparatus 10 given above, printing unit 18 may be, for example, an ink jet printing unit configured for forming an image on a sheet of print media 44, such as a sheet of paper, transparency or fabric. As an ink jet printing unit, for example, printing unit 18 operates one or more ink jet printhead cartridges to eject ink droplets onto the sheet of print media 44 in order to reproduce text and/or images.

Host 14 may be, for example, a personal computer including an input/output (I/O) device 46, such as keyboard and display monitor. Host 14 further includes a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 48, e.g., printer driver software for imaging apparatus 10. Imaging driver 48 is in communication with controller 34 of imaging apparatus 10 via communications link 16. Imaging driver 48 facilitates communication between imaging apparatus 10 and host 14, and may provide formatted print data to imaging apparatus 10, and more particularly, to printing unit 18.

Alternatively, however, all or a portion of imaging driver 48 may be located in controller 34 of imaging apparatus 10. For example, where imaging apparatus 10 is a multifunction AIO machine having standalone capabilities, controller 34 of imaging apparatus 10 may include an imaging driver configured to support a copying function using scanning unit 20, and/or a fax-print function, and may be further configured to support a printer function. In this embodiment, the imaging driver facilitates communication of formatted print data, as determined by a selected print mode, to printing unit 18, and facilitates communication of scanned image data to controller 34.

Printing unit 18 may include, for example, a reciprocating printhead carrier 50 that carries one or more supply items 32, such as for example, a color ink jet printhead cartridge 52 and a monochrome ink jet printhead cartridge 54, containing a supply of imaging substance, e.g., cyan, magenta, yellow and/or black liquid ink. Optionally, printhead carrier 50 may also carry a reflectance sensor 56. Printhead carrier 50 transports ink jet printhead cartridges 52 and 54, and reflectance sensor 56 if so equipped, in a reciprocation manner along a bi-directional main scan axis 58 over an image surface of the sheet of print media 44 during printing and/or sensing operations.

Controller 34 serves to process print data and to operate printing unit 18 during printing, as well as to operate scanning unit 20, process image data obtained via scanning unit 20, and process printhead alignment data obtained by scanning unit 20 or reflectance sensor 56. In order for print data from host 14 to be properly printed by printing unit 18, the RGB data generated by host 14 is converted into data compatible with printing unit 18 and ink jet printhead cartridges 52, 54. Alternatively, monochrome ink jet printhead cartridge 54 may be replaced by another color printhead cartridge, such as a photo printhead cartridge for jetting diluted color and mono inks.

In the embodiment shown in FIGS. 1A-2, scanning unit 20 is in the form of a flatbed scanner having a reciprocating scan bar 60 that moves in relation to a stationary document. However, those skilled in that will recognize that scanning unit 20 may be of other types, such as for example, a sheet feed scanner that transports a document under a stationary scan bar.

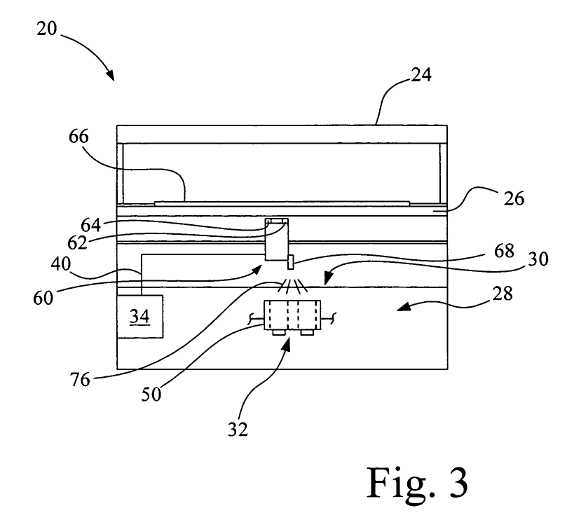

Referring to FIG. 3, scan bar 60 includes a document illuminant 62, e.g., one or more lamps, LED arrays, etc., and a sensor 64, e.g., one or more reflectance sensor arrangements, that are scanned across a document 66 to collect image data relating to document 66. Each of document illuminant 62 and sensor 64 is positioned to the under side of document table, e.g., document glass, 26 and face document 66. Each of document illuminant 62 and sensor 64 is communicatively coupled to controller 34.

Referring to the embodiment of FIG. 2, a light source 68, such as a lamp or light emitting diode, is mounted to imaging apparatus 10 and is positioned to illuminate device access area 28, e.g., to illuminate supply item access area 30 with sufficient work light to aid a user in seeing to perform a supply item installation and/or removal task. For example, light source 68 may be mounted below scanning unit 20, such as in printing unit 18, or may be mounted to scanning unit 20, to provide light to illuminate device access area 28. Further, light source 68 may incorporate a light pipe, a lens, and/or a fiber optics cable, to provide further directivity of light, which in turn provides more options for the placement of the light emitter of light source 68. In other words, as long as the output of light emitted from light source 68 is directed to device access area 28, e.g., supply item access area 30, the light emitter of light source 68 may be located at any convenient location in imaging apparatus 10.

In one example, when scanning unit 20 is moved to the opened position with respect to printing unit 18, as depicted in FIG. 1C, sufficient work light is directed by light source 68 toward supply items 32 to counter the darkness in device access area 28 of imaging apparatus 10 caused by the blocking of ambient light by scanning unit 20 extending over device access area 28 when scanning unit 20 is in the opened position with respect to printing unit 18.

Light source 68 may continuously illuminate device access area 28, e.g., supply item access area 30, or may be coupled to a switch, such as switch 70 shown in FIG. 2, to provide selective illumination of device access area 28, e.g., supply item access area 30.

Switch 70 may be coupled, directly or indirectly, to light source 68 to selectively energize light source 68. Switch 70 may be positioned, for example, to detect when scanning unit 20 is moved, e.g., lifted, from the closed position (e.g., FIG. 1A) toward the opened position (FIG. 1C), so as to activate light source 68. Light source 68 and switch 70 may be coupled to controller 34, with the status of switch 70 being monitored by controller 34 and the activation of light source 68 being controlled by controller 34. Alternatively, light source 68 and switch 70 may have other forms, such as a simple series circuit coupled to a power source. Switch 70 may be, for example, an electromechanical switch, a magnetic switch or an optical switch.

In the embodiment of FIG. 3, light source 68 is attached to the movable scan bar 60. In this embodiment, when scanning unit 20 is moved to the opened position (see FIG. 1C), controller 34 executes program instructions to position reciprocating scan bar 60 such that the light emitted by light source 68 is positioned to illuminate device access area 28 and more particularly, for example, supply item access area 30. In the embodiment of FIG. 3, switch 70 may provide a signal to controller 34 to indicate the desire to move light source 68, via movement of scan bar 60, to the proper illuminating position with respect to device access area 28, in addition to controlling the activation of light source 68.

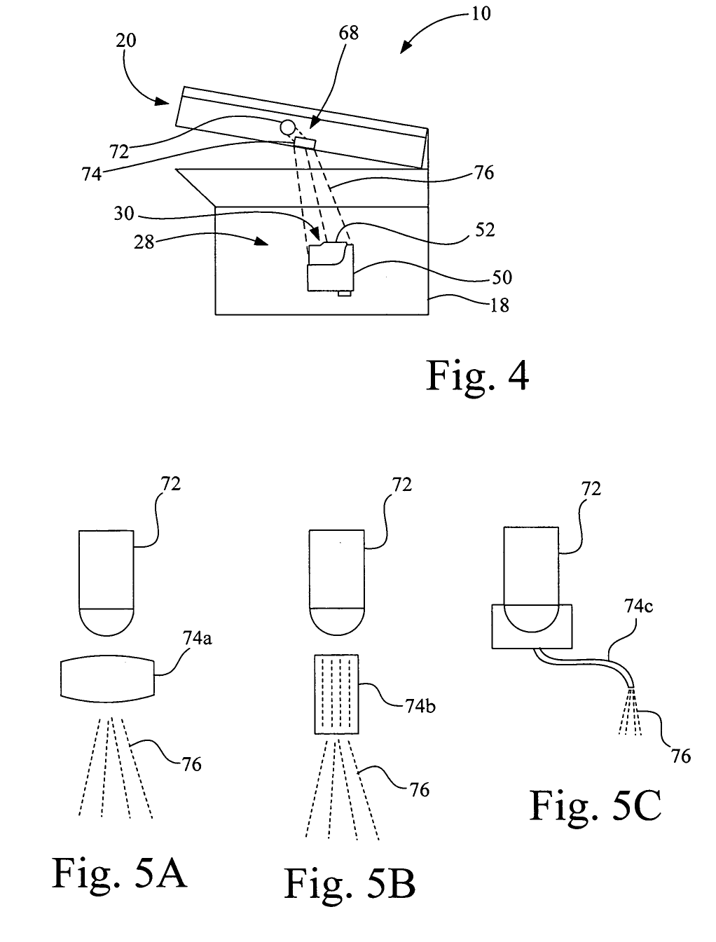

FIG. 4 is a side diagrammatic representation of an embodiment of the present invention where light source 68 of imaging apparatus 10 is used to illuminate device access area 28, e.g., supply item access area 30, of imaging apparatus 10. Light source 68 may be attached to scan bar 60 as in the embodiment of FIG. 3, or may be mounted at some other convenient location in imaging apparatus 10 that permits the delivery of light in a region of imaging apparatus 10 below scanning unit 20 to illuminate device access area 28. In the embodiment of FIG. 4, light source 68 includes at least a light emitter 72, such as a lamp or an LED, and may further include a light directing device 74 for directing light rays 76 to device access area 28, e.g., supply item access area 30. Light directing device 74 may be, for example, a lens 74a (FIG. 5A), a light pipe 74b (FIG. 5B), a fiber optics cable 74c (FIG. 5C), or some combination thereof.

Lens 74a, which may be glass or plastic, may be used to focus or spread light rays 76 at device access area 28, depending on the geometry of lens 74a. Light pipe 74b, which may be glass or plastic, may be used to collect and transport light along a rigid pathway. Fiber optics cable 74c may be used to collect and transport light along a flexible pathway, and thus, permits light emitter 72 to be located at a convenient location available in or on imaging apparatus 10, even below printhead carrier 50 if desired, so long as the location permits fiber optics cable 74c to deliver light rays 76 to device access area 28.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An imaging apparatus having a device access area, comprising a light source mounted to said imaging apparatus, said light source being positioned to illuminate said device access area to counter darkness in said device access area of said imaging apparatus.

2. The imaging apparatus of claim 1, wherein said device access area is a supply item access area.

3. The imaging apparatus of claim 2, wherein said light source is positioned to illuminate said supply item access area with sufficient work light to aid a user in seeing to perform a supply item installation and/or removal task.

4. The imaging apparatus of claim 1, further comprising a switch coupled to said light source to selectively energize said light source.

5. The imaging apparatus of claim 4, further comprising:
a printing unit; and
a scanning unit movably coupled to said printing unit and positioned above said device access area,
said light source being activated by said switch when said scanning unit is lifted.

6. The imaging apparatus of claim 1, further comprising:
a printing unit; and
a scanning unit movably coupled to said printing unit, said scanning unit including a movable scan bar,
said light source being attached to said movable scan bar.

7. The imaging apparatus of claim 6, further comprising a controller coupled to said scanning unit, said controller executing program instructions to move said scan bar to a location such that said light source illuminates a supply item access area.

8. The imaging apparatus of claim 1, further comprising:
a printing unit; and
a scanning unit movably coupled to said printing unit and positioned above said device access area, said light source being positioned below said scanning unit.

9. The imaging apparatus of claim 1, wherein said light source is a light emitting diode.

10. The imaging apparatus of claim 1, wherein said light source includes a lens for directing light emitted by said light source to said device access area.

11. The imaging apparatus of claim 1, wherein said light source includes a light pipe for directing light emitted by said light source to said device access area.

12. The imaging apparatus of claim 1, wherein said light source includes a fiber optics cable for directing light emitted by said light source to said device access area.

13. An imaging apparatus, comprising:
a printing unit including at least one replaceable supply item, and a supply item access area associated with said at least one replaceable supply item;
a scanning unit pivotably attached to said printing unit, said scanning unit having a closed position and an opened position in relation to said printing unit;
a switch positioned to detect when said scanning unit is moved from said closed position toward said opened position; and
a light source coupled to said switch, said light source being positioned to provide light to illuminate said supply item access area.

14. The imaging apparatus of claim 13, wherein said light source includes a light emitting diode.

15. The imaging apparatus of claim 13, wherein said light source includes a lens for directing said light emitted by said light source to said supply item access area.

16. The imaging apparatus of claim 13, wherein said light source includes a light pipe for directing said light emitted by said light source to said supply item access area.

17. The imaging apparatus of claim 13, wherein said light source includes a fiber optics cable for directing said light emitted by said light source to said supply item access area.

18. The imaging apparatus of claim 13, said scanning unit including a movable scan bar, said light source being attached to said movable scan bar.

19. The imaging apparatus of claim 18, further comprising a controller coupled to said scanning unit, said controller executing program instructions to move said scan bar to a location such that said light source illuminates said supply item access area.

20. A method for use with an imaging apparatus having a device access area and a light source mounted to said imaging apparatus, comprising emitting light from said light source to illuminate said device access area of said imaging apparatus to counter darkness in said device access area.

21. The method of claim 20, wherein said device access area is a supply item access area.

22. The method of claim 21, further comprising positioning said light source to illuminate said supply item access area with sufficient light to aid a user in seeing to perform a supply item installation and/or removal task.
